(19) United States
(12) Patent Application Publication
(10) Pub. No.: US 2016/0330916 A1
(43) Pub. Date: Nov. 17, 2016

(54) FLOWER POT

(71) Applicant: Vanguard Plastics Corp., Southington, CT (US)

(72) Inventor: Christopher Budnick, Southington, CT (US)

(21) Appl. No.: 15/151,813

(22) Filed: May 11, 2016

Related U.S. Application Data
(60) Provisional application No. 62/161,922, filed on May 15, 2015.

(51) Int. Cl. A01G 9/02

(52) U.S. Cl. CPC A01G 9/02

(57) ABSTRACT

A container for a plant, the container including: a body and a plant tube, wherein the body includes a top surface with a first body opening therein, a front surface connected to the top surface, a side surface connected to the top surface and the front surface, and a bottom surface connected to the front surface and the side surface; wherein the plant tube comprises a container body defining a container cavity, and a top portion connected to the container body, wherein the top portion comprises at least one tube opening; wherein the plant tube is configured to extend at least partially through the first body opening; wherein an outer diameter of the plant tube is less than an inner diameter of the first body opening; and wherein an outer diameter of the top portion of the plant tube is greater than an inner diameter of the first body opening.

### CROSS-REFERENCE TO RELATED APPLICATION

This disclosure claims the benefit of U.S. Provisional Application No. 62/161,922, filed on May 15, 2015, the entire content of which is hereby incorporated by reference.

### BACKGROUND

There is an increasingly popular trend of growing indoor gardens, especially in the kitchen for easy access to fresh and inexpensive herbs. This becomes an issue, however, when conventional flower pots compete with appliances for valuable counterspace. Counterspace also is often not in an optimal location to ensure the plant has sufficient exposure to sunlight. It would be desirable, therefore, to be able to mount a flower pot to a wall or other surface to save space and allow for optimal growing conditions.

Switching plants from one pot to another often takes some time and involves messy soil or water. It would also be desirable to be able to more easily insert or remove a plant and its surrounding sustenance from a flower pot quickly and easily without the need for transplanting and cleanup.

### SUMMARY

A container for a plant, the container comprising: a body and a plant tube, wherein the body comprises a top surface with a first body opening therein, a front surface connected to the top surface, a side surface connected to the top surface and the front surface, and a bottom surface connected to the front surface and the side surface; wherein the plant tube comprises a container body defining a container cavity, and a top portion connected to the container body, wherein the top portion comprises at least one tube opening; wherein the plant tube is configured to extend at least partially through the first body opening; wherein an outer diameter of the plant tube is less than an inner diameter of the first body opening; and wherein an outer diameter of the top portion of the plant tube is greater than an inner diameter of the first body opening is provided.

A method of using the container for a plant described herein, the method comprising: disposing a plant in the plant tube, is provided.

A system comprising the container and a plant, is provided.

### BRIEF DESCRIPTION OF THE DRAWINGS

The above and other aspects, advantages and features of this disclosure will become more apparent by describing in further detail exemplary embodiments thereof with reference to the accompanying drawings, where like numbers indicate like parts.

FIG. 1 is a perspective view of an embodiment of the container in a combined configuration, in a front-view of an upright orientation;

FIG. 2 is a side view of an embodiment of the container in a combined configuration;

FIG. 3 is a rear view of an embodiment of the container in a combined configuration;

FIG. 4 is a front perspective view of an embodiment of the plant tube in an upright orientation; and

FIG. 5 shows a cross-sectional view of the plant tube.

### DETAILED DESCRIPTION

A container for a plant, the container comprising: a body and a plant tube, is provided. The body can have a number of configurations, such as an elongated shape having one or more body openings at a top surface. The plant tube is configured to fit into a body opening.

More specifically, a container for a plant is provided, the container comprising a body and a plant tube, wherein the body comprises a top surface with a first body opening therein, a front surface connected to the top surface, a side surface connected to the top surface and the front surface, and a bottom surface connected to the front surface and the side surface; wherein the plant tube comprises a container body defining a container cavity, and a top portion connected to the container body, wherein the top portion comprises at least one tube opening; wherein the plant tube is configured to extend at least partially through the first body opening; wherein an outer diameter of the plant tube is less than an inner diameter of the first body opening; and wherein an outer diameter of the top portion of the plant tube is greater than an inner diameter of the first body opening is provided. The plant tube can be disposed in the first body opening. The plant tube can be configured to contain a fluid, growing medium, water gel, support, nutrition, or other substance.

The container can further comprise a vent, which can be disposed in the front surface of the body, a side surface of the body, the bottom surface of the body, or the back surface of the body. A vent can be used to allow air to circulate into or onto a plant tube. A vent can be decorational. A vent can reduce the weight of the container.

The container can be attached to a wall or other surface using a receiver. The receiver can be disposed on a side surface of the body, the bottom surface of the body, the top surface of the body, or a combination of the surfaces, i.e., there can be more than one receiver to allow for flexibility in attachment options.

The body can be fabricated as a unitary indivisible part, or any number of surfaces can be fabricated separately and fitted together, i.e., using adhesives, attachment pins, female attachment slots and corresponding male attachment structures, or other ways of attachment.

The plant tube can be a unitary indivisible part, or the container body and top portion can be separate. The top portion of the plant tube is designed to have an opening for a plant. When the plant tube is a unitary indivisible part, the opening can be in the top portion itself. When the container body and top portion are separate, the top portion can comprise a tube cap which fits securely over a tube opening, wherein the tube cap comprises at least one opening. The tube cap can be removably attached to the plant tube. The top portion of the plant tube can be fixedly attached to the plant tube, for example, by using a “flip top” where a small section of the top portion is attached to the plant tube and the top can be flipped open, for example, to insert or remove a plant, and then the top can be closed.

A plant seed can be inserted into the opening, where the container cavity contains a growing medium, e.g., a potting medium, or an already grown or partially grown plant can be inserted into the opening, where the container cavity contains one or more of a growing medium, a support such as foam, a sand, or other supporting material, a gel, or water, for example. In an embodiment a stem of a plant can be inserted into the opening. The container cavity can comprise any suitable growing medium or potting media, and may comprise any suitable combination of water, soil, vermiculite, peat moss, a wood fiber such coconut fiber, and a gel, for example. In an embodiment the growing medium is selected to provide the plant suitable support.

The plant tube can be impermeable or substantially impermeable to liquid, so the liquid in the plant tube can be contained.

The plant tube can be inserted into the body and the body can comprise an internal shoulder configured to restingly support the plant tube to hold the plant tube in place. The top portion of the plant tube can have an outer diameter greater than an inner diameter of a body opening, and the plant tube can be inserted into the body so that the top portion holds the plant tube in the body opening.

There can be a single opening in the body to hold one plant tube, or a plurality of body openings configured to hold a plurality of plant tubes. Each plant tube can comprise one tube opening, or a plurality of tube openings.

The container can comprise a lobe having a semicircular cross-section, or other cross-section. This aspect is further described below.

The container for a plant can be used by disposing a plant in the plant tube and inserting the plant tube at least partially into the cavity of the body.

A system comprising the container and a plant is provided. The plant can be disposed in the plant tube and the plant tube is disposed at least partially within the cavity of the body portion through the first body opening.

A variety of plants and plant seeds can be used. Non-limiting examples include herbs, flowers, edible plants, ornamental plants, medicinal plants, and other plants.

More specifically, provided is a container comprising: a body and at least one plant tube, wherein the body comprises an outer body structure at least partially enclosing a cavity, and an opening sufficient for inserting a plant tube at least partially into the cavity of the body, and an internal shoulder configured to restingly hold the plant tube, and wherein the plant tube comprises a container comprising a container body defining a container cavity, and a tube cap, wherein the plant tube comprises at least one opening, and wherein the plant tube is configured to extend at least partially through the opening, wherein the at least one opening of the plant tube is at least partially aligned with the opening of the body.

In an embodiment, provided is a container for a plurality of plants, the container comprising: a body, wherein the body is a unitary indivisible part, which body comprises a top surface comprising three body openings, a front surface comprising three lobes, wherein each lobe is a semicircular cross-section of a hemi frustoconical shape, and a vent, a side surface, which is connected to the top surface and the front surface, the side surface comprising a receiver which is disposed on the side surface of the body, wherein the receiver is configured to receive a fastener, and a bottom surface, which is connected to the front surface and side surface, wherein an intersection between a first surface and a second surface is curved; and three plant tubes disposed in the body, wherein each plant tube comprises a tube portion and a top portion having a first plant tube opening, wherein each plant tube is disposed in a corresponding body opening of the body, and wherein each plant tube is removably disposed in the body, wherein each plant tube is configured to contain a fluid, wherein the top portion of each plant tube comprises a second plant tube opening, wherein an outer diameter of the tube portion of each plant tube is less than an inner diameter of a corresponding first body opening of the top surface of the body, and wherein an outer diameter of the top portion of each plant tube is greater than an inner diameter of the corresponding first opening of the top surface of the body.

The invention now will be described with reference to the drawings, in which various embodiments are shown. This invention may, however, be embodied in many different forms, and should not be construed as limited to the embodiments and description set forth herein.

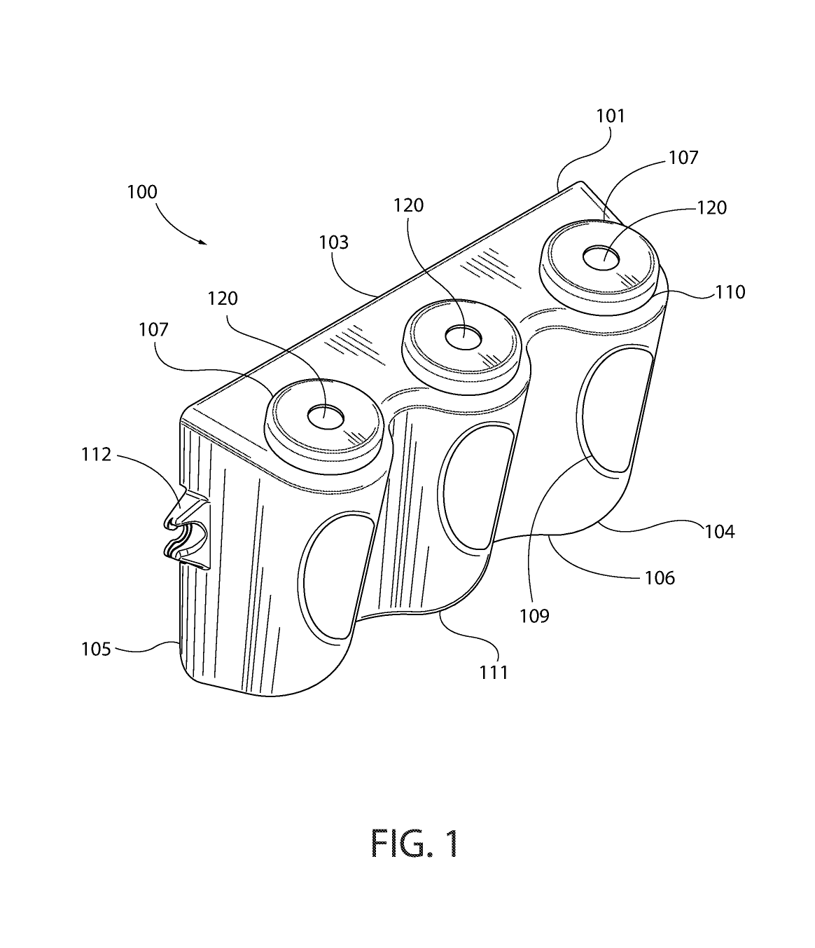

Shown in FIG. 1 is a container 100 comprising: a body 101 and a plant tube 102, wherein body 101 includes a top surface 103 with a first body opening 110 therein, a front surface 104 connected to top surface 103, a side surface 105 connected to top surface 103 and front surface 104, and a bottom surface 106 connected to front surface 104 and side surface 105; and a plant tube 102. Plant tube 102 comprises a container body defining a container cavity, and a top portion 107 connected to the container body, wherein top portion 107 includes a tube opening 120, wherein an outer diameter of plant tube 102 is less than an inner diameter of first body opening 110, and wherein an outer diameter of top portion 107 of the plant tube is greater than an inner diameter of first body opening 110. The first body opening may be configured based on the dimensions and configuration of the plant tube.

Also shown in FIG. 1 are vents 109, which can be arranged in any desired arrangement, such as decorative. If desired, one or more vents can be used. In an embodiment, no vents are present. Vents are useful for decorative purposes, as well as to allow air to circulate in the container.

Also shown in FIG. 1 is receiver 112, wherein receiver 112 is configured to receive a fastener, such as a wall anchor, a nail, or other fastening device. Receiver 112 is disposed on a side surface of the body, as shown in FIG. 1. A receiver can also be disposed on the top surface or the bottom surface of the body, for example. FIG. 1 shows the front surface of the body comprising a lobe 111. The lobe may comprise any suitable shape, and may be rectilinear, curvilinear, triangular, have a semi-circular cross-sectional hemi-frustoconical shape, or a combination thereof. A lobe may be a similar shape and size as the plant tube, or can be any other suitable shape and size.

The body can have any suitable shape, and may be rectilinear, curvilinear, triangular, have a hemi-frustoconical shape, or any combination thereof. In an embodiment, the body is a unitary, indivisible part, as shown in FIG. 1.

FIG. 1 shows a view of the container in a combined configuration with the body and plant tube both present, in a front-view of an upright orientation.

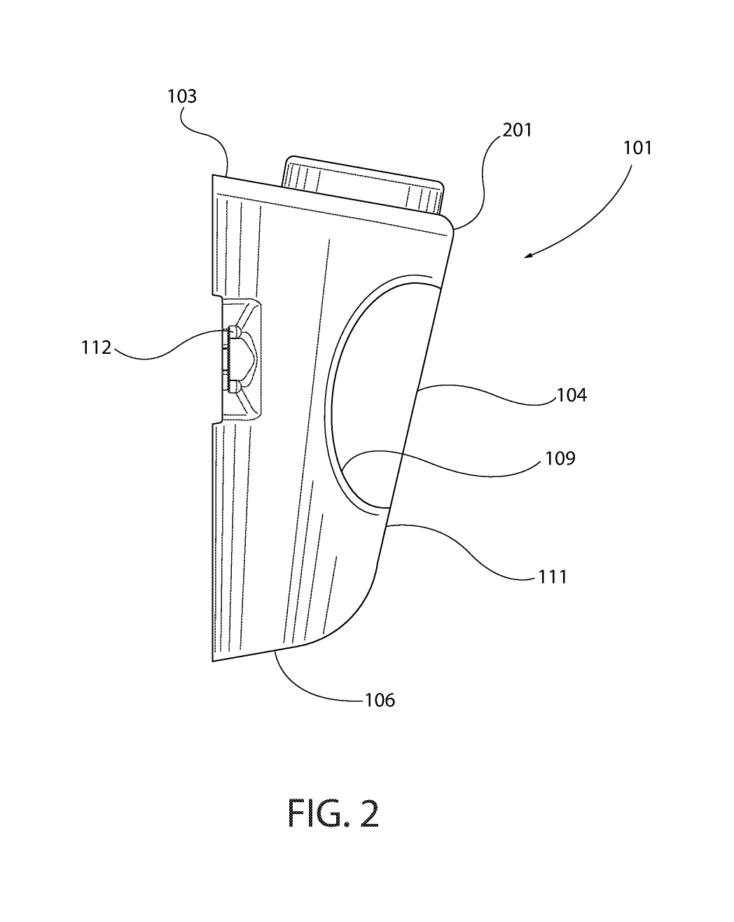

FIG. 2 is a side view of an embodiment of the container in a combined configuration with the body and plant tube both shown. FIG. 2 shows body 101 and plant tube 102, wherein body 101 includes top surface 103, front surface 104 connected to top surface 103, bottom surface 106 connected to front surface 104. FIG. 2 shows vent 109, lobe 111, and receiver 112.

An intersection between any two surfaces of the body can be curvilinear, at a right angle, at an oblique angle, or any other suitable arrangement, for design, fabrication, or other reasons. FIG. 2 shows an intersection 201 between the top surface and front surface, as well as an intersection between the front surface and the bottom surface. An intersection between a first surface and a second surface can be any location where one of the front surface, the top surface, the side surface, or the bottom surface meets with another.

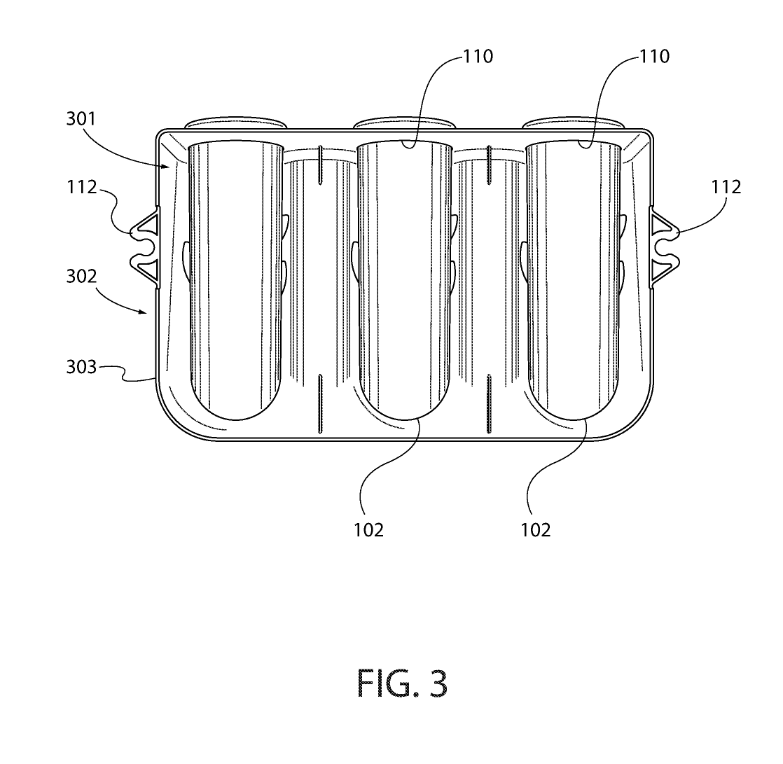

As shown in FIG. 3, the body may comprise a container body defining a container cavity 301, which cavity 301 is configured to receive a plant tube 102 or some portion thereof when the plant tube is disposed in first body opening 110. The body may include a back portion 302 which may be configured to comprise a third opening 303 as shown in FIG. 3. FIG. 3 also shows receiver 112, plant tube 102, and body opening 110. As shown in FIG. 3, back portion 302 may be configured to lay flush against an adjoining surface, such as a wall or post. The back portion can be a solid form, can be partially solid, or can be open, as is shown in FIG. 3. An outer diameter of the plant tube is less than an inner diameter of the first body opening so that the plant tube may be disposed within a cavity 301 of the body by entering through the first body opening.

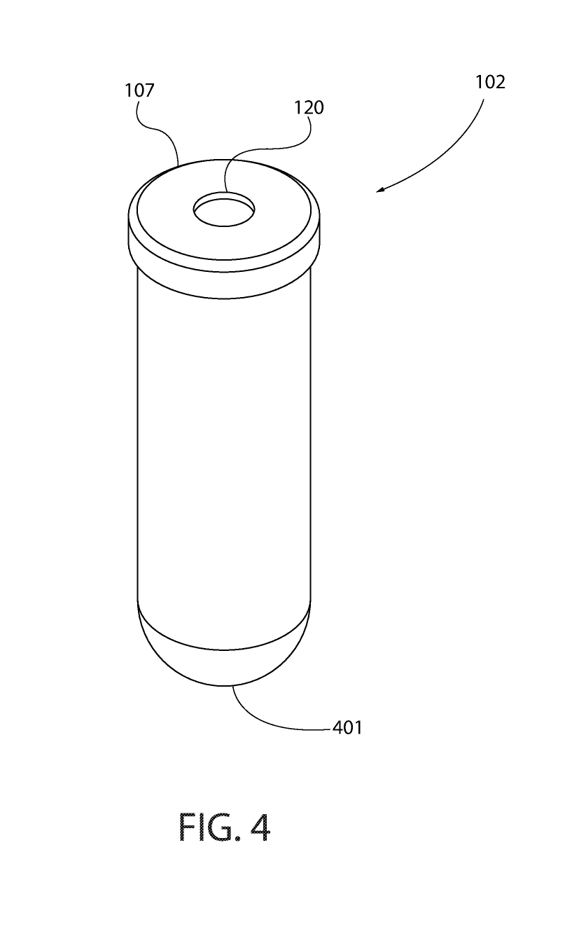

FIG. 4 shows a view of a plant tube. An inner diameter of the opening 120 in plant tube 102 may be less than an inner diameter of the plant tube, as shown in FIG. 4, to minimize loss of moisture through evaporation. In an embodiment, the top portion 107 of the plant tube 102 is removably attached to the plant tube.

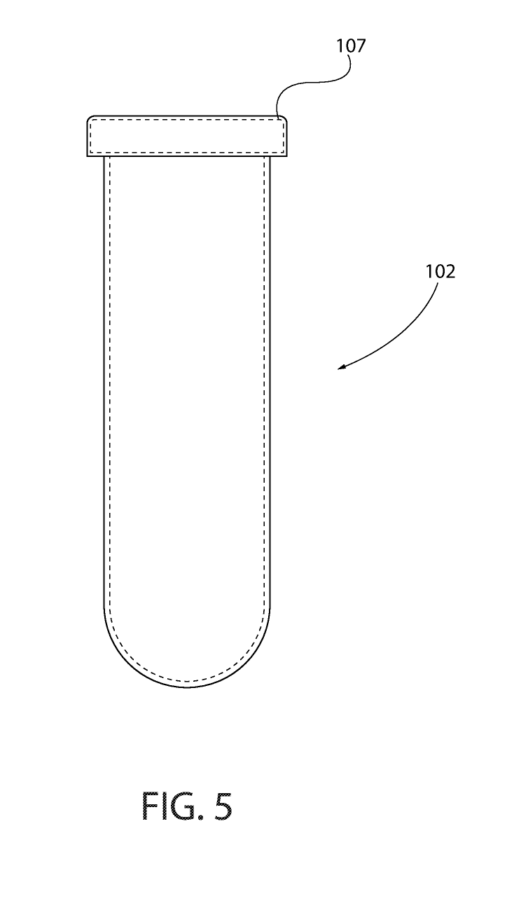

FIG. 5 shows a cross-sectional view of the plant tube 102.

The plant tube may have any suitable dimensions of any suitable shape and may be rectilinear, curvilinear, triangular, have a tube shape, or a combination thereof. In an embodiment, the plant tube is a tube shape comprising a second opening 120 in the top portion 107 and a closed, U-shaped on the opposite, bottom end 401 as shown in FIG. 4. In an embodiment, the shape of the plant tube generally corresponds with the shape of the first body opening.

As shown in FIG. 1, in an embodiment the front surface of the body comprises a lobe 111. The lobe may comprise any suitable shape, and may be rectilinear, curvilinear, triangular, have a semi-circular cross-sectional hemi-frustoconical shape, or a combination thereof. FIG. 2 shows lobe 111 having a semi-circular cross-sectional hemi-frustoconical shape, as further defined below. The body may comprise a plurality of lobes. In an embodiment, the body may comprise three lobes, each lobe having a semi-circular cross-sectional, hemi-frustoconical shape as shown in FIG. 1. In an embodiment, the body may comprise a plurality of openings. In an embodiment, the body can comprise three first body openings, as shown in FIG. 1. In an embodiment, lobe may be configured based on the dimensions and configuration of plant tube.

The term lobe, as used herein, refers to any protrusion extending from a surface of the container. The protrusion may be solid throughout, may enclose a cavity, or some combination thereof. The phrase semi-circular cross sectional, hemi-frustoconical shape, as used herein, refers to any suitable frustoconical shape divided longitudinally to produce a curved lobe in front surface 104 of body 101, as shown in FIG. 2, for example. In an embodiment, lobe may be an inverted hemi-frustoconical shape, meaning that the upper radius of the lobe is greater than the lower radius of the lobe, for example, as shown in FIG. 2.

The body and plant tube may have any suitable dimensions, and may be made from any suitable material. Materials that can be used to make the body and plant tube include a variety of polymeric materials, such as those materials that can be injection molded, or otherwise fabricated, or materials that can be used in additive manufacturing processes, for example. Glass materials can also be used for the body and plant tube. The body and plant tube can be made of different or the same materials. Portions of the body and plant tube, such as the container body and top portion, can be made of different or the same materials. The body and plant tube may each independently comprise a polymer such as a polyolefin, such as a homopolymer or a copolymer of a monoolefin or a diolefin, for example polypropylene (“PP”), or polyethylene (“PE”) which optionally can be crosslinked and can be, for example, high density polyethylene (“HDPE”), low density polyethylene (“LDPE”), linear low density polyethylene (“LLDPE”), or branched low density polyethylene (“BLDPE”); a polymer derived from an α,β-unsaturated acid which is obtained by polymerizing the unsaturated bond in positions α and β relative to the acid functionality, such as a polyacrylate, a polymethacrylate, or a polyacrylonitrile; a polycarbonate; or a natural polymers such as cellulose. A combination comprising at least one of the foregoing may be used. In an embodiment the body may comprise a metal such as stainless steel, wood, or a ceramic such as terra cotta. A combination comprising at least one of the foregoing may be used.

The container may also include an adhesive on any suitable surface to allow the container to be permanently or removably affixed to a surface. The container may be placed on a horizontal surface, such as a counter, in which case the bottom surface is desirably horizontal. The container may be attached to a vertical surface, such as a well, by use of a fastener, adhesive, or other method of attachment.

Flower pots often include a means for draining off excess fluid, and in an embodiment the plant tube may be comprised of a material that is not water-tight. In another embodiment, the plant tube may comprise multiple openings configured for plant growth and drainage. In an embodiment, the plant tube may be impermeable to liquid. In an embodiment, the plant tube is removably disposed in the body. In an embodiment, the plant tube may be a unitary indivisible part.

In an embodiment, an outer diameter of the top portion of the plant tube is greater than an inner diameter of the first body opening so that the plant tube may be restingly affixed in the body when it is disposed in the first body opening, without falling through the first body opening due to gravity or other forces.

Any suitable number of plant tubes may be used, such as 1 to 20, or 3 to 15 wherein each plant tube is disposed in a corresponding first body opening of the body. In an embodiment there may be three plant tubes disposed through three first body openings of the body, as shown in FIG. 1.

Any suitable plant-growing medium may be disposed in the plant tube, along with any suitable plant, or a seed to be germinated. Representative plant-growing mediums include water, soil, peat moss, perlite, vermiculite, sand, water gel, or a combination thereof. In an embodiment, the container includes a gel which is disposed in the plant tube. Any suitable water gel may be used. Commercially available plant gels include Miracle-Gro Water Storing Crystals, Technaflora Rootech Gel for Plants, and WORLD PRIDE Clear Water Soil Crystals Gel Ball Beads, available on Amazon.com. In an embodiment, a support, such as a foam, sand, or other support medium can be disposed in the plant tube, for arranging a cut flower or plant placed in the plant tube, for example.

It has been surprisingly discovered that the disclosed container configuration is advantageous because a grower or florist can arrange plants in the plant tube, and then press-fit the tube into the bottom portion. Use of the plant tube with a water gel can be useful in certain applications. Some benefits of using the plant tube with a water gel include avoiding the need for frequent watering, avoiding spillage, avoiding the dangers of glass, providing improved shelf life, providing improved display life, or a combination thereof. In addition, the described container is lighter weight than alternatives such as clay pots, which can provide reduced shipping cost.

In a specific embodiment, a container comprising: a body and at least one plant tube, wherein the body comprises an outer body structure at least partially enclosing a cavity, and an opening sufficient for inserting a plant tube at least partially into the cavity of the body, and an internal shoulder configured to restingly hold the plant tube, and wherein the plant tube comprises a container comprising a container body defining a container cavity, and a tube cap, wherein the plant tube comprises at least one opening, and wherein the plant tube is configured to extend at least partially through the opening in the bottom portion into the cavity, wherein the at least one opening of the plant tube is at least partially aligned with the opening of the bottom portion, is provided.

A method of using a container for a plant is provided, the method comprising disposing a plant in a plant tube. The method can include inserting the plant tube at least partially into the cavity of the body.

A system comprising the container as described herein and a plant is also provided. In the system, the plant can be disposed in the plant tube of the container, and the plant tube can be disposed at least partially within the cavity of the body portion through the first body opening.

In this disclosure some but not all embodiments of this disclosure are described. This disclosure may be embodied in many different forms and is not be construed as limited to the embodiments set forth herein; rather, these embodiments are provided so that this disclosure will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third,” etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Exemplary embodiments are described herein with reference to illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

What is claimed is:

1. A container for a plant, the container comprising:
a body; and
a plant tube, wherein the body comprises
a top surface with a first body opening therein,
a front surface connected to the top surface,
a side surface connected to the top surface and the front surface, and
a bottom surface connected to the front surface and the side surface,
wherein the plant tube comprises a container body defining a container cavity, and a top portion connected to the container body, wherein the top portion comprises at least one tube opening,
wherein the plant tube is configured to extend at least partially through the first body opening,
wherein an outer diameter of the plant tube is less than an inner diameter of the first body opening, and
wherein an outer diameter of the top portion of the plant tube is greater than an inner diameter of the first body opening.

2. The container of claim 1, wherein the plant tube is disposed in the first body opening.

3. The container of claim 1, wherein the plant tube is configured to contain a fluid.

4. The container of claim 1, further comprising a vent, which is disposed in the front surface of the body.

5. The container of claim 1, further comprising a receiver which is disposed on a surface of the body, wherein the receiver is configured to receive a fastener.

6. The container of claim 1, wherein the body and plant tube are each a unitary indivisible part.

7. The container of claim 1, wherein the plant tube further comprises a gel disposed in the container cavity.

8. The container of claim 1, wherein the plant tube is impermeable to liquid.

9. The container of claim 1, wherein the plant tube comprises a tube cap which fits securely over a tube opening, wherein the tube cap comprises at least one opening.

10. The container of claim 9, wherein the tube cap is removably attached to the plant tube.

11. The container of claim 1, wherein the plant tube is removably attached to the body.

12. The container of claim 1, wherein the body comprises an internal shoulder configured to restingly support the plant tube to hold the plant tube in place.

13. The container of claim 1, wherein the body comprises a plurality of body openings configured to hold a plurality of plant tubes.

14. The container of claim 1, wherein the plant tube comprises a plurality of tube openings.

15. The container of claim 1, wherein the front surface of the body comprises a lobe having a semicircular cross-section.

16. A method of using the container for a plant of claim 1, the method comprising:
disposing a plant in the plant tube.

17. The method of claim 16, further comprising inserting the plant tube at least partially into the cavity of the body.

18. A system comprising the container of claim 1; and a plant.

19. The system of claim 18, wherein the plant is disposed in the plant tube of the container, and the plant tube is disposed at least partially within the cavity of the body portion through the first body opening.

20. A container comprising:
a body; and
at least one plant tube, wherein the body comprises
an outer body structure at least partially enclosing a cavity, and
an opening sufficient for inserting a plant tube at least partially into the cavity of the body, and
an internal shoulder configured to restingly hold the plant tube,
wherein the plant tube comprises a container comprising
a container body defining a container cavity, and
a tube cap,
wherein the plant tube comprises at least one opening, and
wherein the plant tube is configured to extend at least partially through the opening, wherein the at least one opening of the plant tube is at least partially aligned with the opening of the body.
